(19) United States
(12) Patent Application Publication
(10) Pub. No.: US 2026/0360191 A1
(43) Pub. Date: Nov. 12, 2026

(54) TRAVEL MANAGEMENT EQUIPMENT FOR OFF-ROAD VEHICLE AND OFF-ROAD VEHICLE

(71) Applicant: KAWASAKI MOTORS, LTD., Akashi-shi (JP)

(72) Inventor: Toshiyuki TSUBONE, Akashi-shi (JP)

(73) Assignee: KAWASAKI MOTORS, LTD., Akashi-shi (JP)

(21) Appl. No.: 19/650,399

(22) Filed: Apr. 17, 2026

(30) Foreign Application Priority Data
May 8, 2025 (JP) 2025-078058

(51) Int. Cl. G07C 5/00; G08B 21/18

(52) U.S. Cl. CPC G07C 5/008; G08B 21/18

(57) ABSTRACT

Processing circuitry of travel management equipment for an off-road vehicle is configured to: determine that a travel abnormality has occurred in the off-road vehicle during travel; acquire after-abnormality vehicle information indicating a vehicle state of the off-road vehicle after an occurrence of the travel abnormality; and transmit report information including the after-abnormality vehicle information to rescue-side equipment.

### CROSS-REFERENCE TO RELATED APPLICATION

This application claims priority to and the benefit of Japanese Patent Application No. 2025-078058 filed on May 8, 2025, the entire disclosure of which is incorporated herein by reference.

### BACKGROUND OF THE INVENTION

### Field of the Invention

The present disclosure relates to travel management equipment for an off-road vehicle, and to an off-road vehicle.

### Description of the Related Art

Off-road vehicles that travel on uneven terrain, such as rough terrain or deserts, have been known. The off-road vehicles can freely travel on vast land without fixed roads. As a prior art document for the present disclosure, there is Japanese Laid-Open Patent Application Publication No. 2021-189896.

### SUMMARY OF THE INVENTION

When an off-road vehicle travels by autonomous driving, a travel abnormality may occur in the off-road vehicle due to uneven terrain.

An object of one aspect of the present disclosure is to perform an appropriate rescue operation when a travel abnormality occurs in an off-road vehicle during autonomous driving.

Travel management equipment for an off-road vehicle according to one aspect of the present disclosure is equipment that manages travel of the off-road vehicle, and includes processing circuitry. The processing circuitry is configured to: determine that a travel abnormality has occurred in the off-road vehicle during the travel; acquire after-abnormality vehicle information indicating a vehicle state of the off-road vehicle after an occurrence of the travel abnormality; and transmit report information including the after-abnormality vehicle information to rescue-side equipment.

Travel management equipment for an off-road vehicle according to another aspect of the present disclosure is equipment that manages travel of the off-road vehicle, and includes processing circuitry. The processing circuitry is configured to: determine that a travel abnormality has occurred in the off-road vehicle during the travel; acquire before-abnormality information indicating information related to the off-road vehicle before an occurrence of the travel abnormality; and transmit report information including the before-abnormality information to rescue-side equipment.

According to one aspect of the present disclosure, by notifying the rescue-side equipment of the vehicle state of the autonomously-driven off-road vehicle in which the travel abnormality has occurred, the rescue side can grasp a measure necessary to resolve the travel abnormality.

### BRIEF DESCRIPTION OF THE DRAWINGS

FIG. 1 is a schematic diagram of a travel management system for an off-road vehicle according to an embodiment.

FIG. 2 is a block diagram of a control system of the off-road vehicle shown in FIG. 1.

FIG. 3 is a block diagram of a server show in FIG. 1.

FIG. 4 is a flowchart for explaining processing of a travel management ECU shown in FIG. 2.

FIG. 5 is a flowchart for explaining processing of the server shown in FIG. 3.

### DETAILED DESCRIPTION

Hereinafter, an embodiment will be described with reference to the drawings.

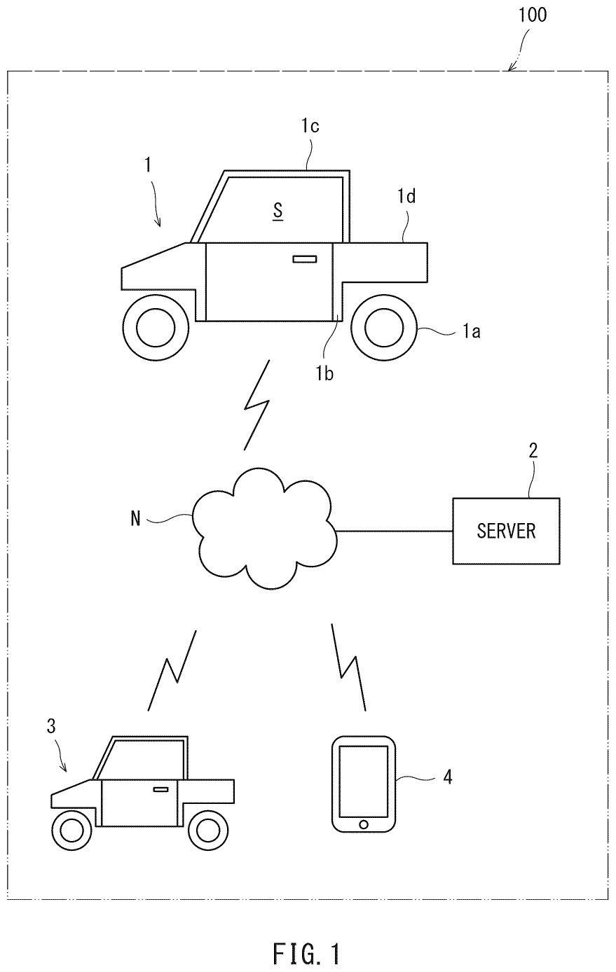

FIG. 1 is a schematic diagram of a travel management system 100 for an off-road vehicle 1 according to the embodiment. As shown in FIG. 1, the travel management system 100 includes the off-road vehicle 1 and a server 2 that is communicable with the off-road vehicle 1 through a communication network N. The off-road vehicle 1 travels on uneven terrain, such as forests, deserts, and rocky areas. When the off-road vehicle 1 travels on uneven terrain, the road surface condition is often irregular, and therefore, the off-road vehicle 1 is more likely to be brought into a non-travelable state, such as a rollover state or a stuck state, as compared with when the off-road vehicle 1 travels on even terrain.

The off-road vehicle 1 is, for example, a four-wheeled vehicle. The off-road vehicle 1 has an autonomous driving function. The autonomous driving function is a function by which the off-road vehicle 1 recognizes a surrounding condition without relying on the operation of a person and autonomously travels. In autonomous driving, the amount of surrounding information reflected in vehicle driving tends to be smaller than that in manual driving. Therefore, the off-road vehicle 1 is more likely to be brought into the non-travelable state, such as the rollover state or the stuck state. The off-road vehicle 1 may be remotely operated or may have both the autonomous driving function and a manual driving function by a person.

The off-road vehicle 1 includes four wheels 1a and a body 1b supported by the wheels 1a. The body 1b includes a cabin frame 1c surrounding an interior space S in which an occupant seat is located. The cabin frame 1c serves as a ROPS (Roll-Over Protective Structure). The occupant seat may be omitted for unmanned driving. Even in this case, it is preferable that the off-road vehicle 1 include a structure corresponding to the ROPS.

The interior space S surrounded by the cabin frame 1c is exposed to the outside. The off-road vehicle 1 may include a wall that separates the interior space S and an exterior space. A cargo bed 1d is located behind the cabin frame 1c. The cargo bed 1d defines a recessed loading space that is open to the outside. For example, when cargo is loaded on the cargo bed 1d, the center of gravity of the off-road vehicle 1 may become higher than that when no cargo is loaded, and the center of gravity of the off-road vehicle 1 may be offset to the left or the right from the center in a vehicle width direction. In this case, the possibility of rollover of the off-road vehicle 1 increases.

It is preferable that the off-road vehicle 1 include a structure for traveling on uneven terrain. For example, the off-road vehicle 1 may include a low pressure tire for improving grip performance on irregular road surfaces. The off-road vehicle 1 may be configured to be switchable between a two-wheel drive state and a four-wheel drive state. The off-road vehicle 1 may be configured to be switchable between a differential state and a differential lock state.

The off-road vehicle 1 may include another structure as the structure for traveling on uneven terrain. For example, the off-road vehicle 1 may include a winch structure. Thus, even when the off-road vehicle 1 enters the rollover state or the stuck state, the off-road vehicle 1 can easily recover from such a state. The off-road vehicle 1 may be configured to be able to change the behavior of a suspension, a stabilizer, or the like in accordance with a traveling state.

The server 2 is communicable with a wireless communicator of the off-road vehicle 1 through the communication network N and is also communicable with a wireless communicator of another vehicle 3 through the communication network N and an information processing terminal 4 possessed by a person. The vehicle 3 may have the same configuration as the off-road vehicle 1.

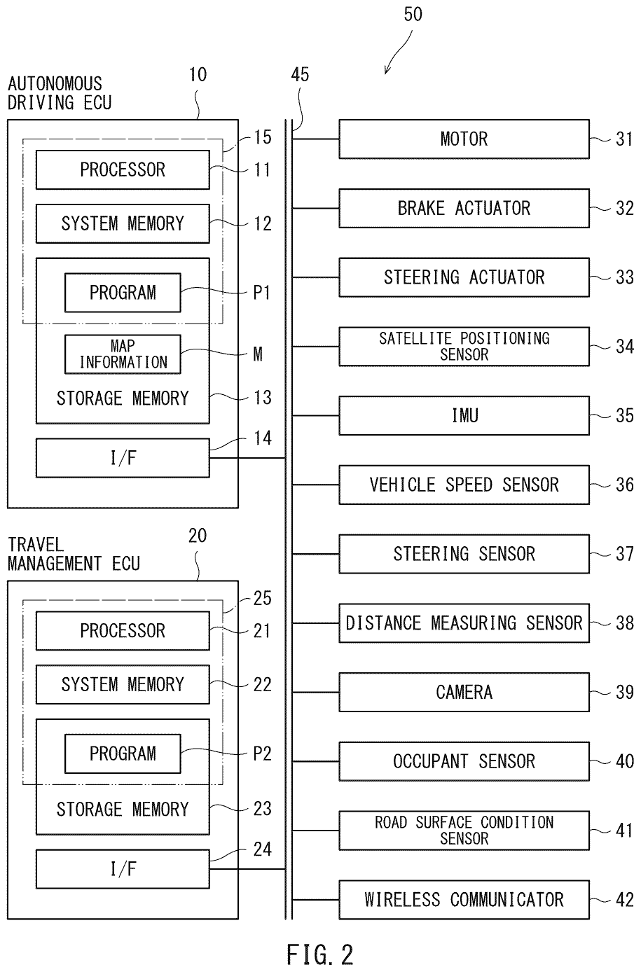

FIG. 2 is a block diagram of a control system 50 of the off-road vehicle 1 shown in FIG. 1. As shown in FIG. 2, the control system 50 of the off-road vehicle 1 includes an autonomous driving ECU 10. The autonomous driving ECU 10 is an autonomous driving control device that causes the off-road vehicle 1 to perform the autonomous driving. A motor 31, a brake actuator 32, and a steering actuator 33 are electrically connected to the autonomous driving ECU 10 through a communication bus 45. The motor 31 serves as a propulsion drive source.

The motor 31 is, for example, an internal combustion engine or an electric motor. However, the off-road vehicle 1 may be a hybrid vehicle including the motor 31 that is a combination of the internal combustion engine and the electric motor. The motor 31 drives wheels serving as driving wheels. The brake actuator 32 drives brake equipment that brakes wheels serving as braked wheels of the off-road vehicle 1. The steering actuator 33 steers front wheels serving as steered wheels of the off-road vehicle 1. The autonomous driving ECU 10 controls the motor 31, the brake actuator 32, and the steering actuator 33 such that the off-road vehicle 1 autonomously travels without requiring the operation of a driver.

A vehicle state detection sensor and a surrounding condition detection sensor are electrically connected to the communication bus 45. The vehicle state detection sensor detects a vehicle state, and the surrounding condition detection sensor detects a surrounding condition of the vehicle. In the present embodiment, the vehicle state detection sensor includes a satellite positioning sensor 34, an IMU 35, a vehicle speed sensor 36, a steering sensor 37, and an occupant sensor 40. In the present embodiment, the surrounding condition detection sensor includes a distance measuring sensor 38, a camera 39, and a road surface condition sensor 41.

The satellite positioning sensor 34 acquires position information indicating the position of the off-road vehicle 1 by receiving radio waves transmitted from an artificial satellite using a satellite positioning system, such as Global Navigation Satellite System (GNSS). The satellite positioning sensor 34 may detect the position of the off-road vehicle 1 in three-dimensional coordinates.

The IMU 35 is an inertial measurement unit. The IMU 35 includes a gyro sensor and a three-axis acceleration sensor. The gyro sensor detects angular velocities around three axes orthogonal to each other. The three-axis acceleration sensor detects accelerations in directions along the three axes orthogonal to each other. The IMU 35 can detect a direction of gravitational acceleration, and therefore, can detect vehicle postures in the stuck state and the rollover state.

The vehicle speed sensor 36 detects a traveling speed of the off-road vehicle 1. The vehicle speed sensor 36 may be, for example, a sensor that detects a rotational speed of the wheel 1a. The traveling speed of the off-road vehicle 1 may be acquired by integrating the acceleration detected by the IMU 35 or may be acquired by calculating the amount of change per unit time in the position detected by the satellite positioning sensor 34. The steering sensor 37 detects a steering angle of the front wheel of the off-road vehicle 1.

The distance measuring sensor 38 three-dimensionally detects the shape of an obstacle around the off-road vehicle 1 by three-dimensionally measuring a distance to the obstacle. The distance measuring sensor 38 detects position data of an outer surface of the obstacle around the off-road vehicle 1 by receiving reflected waves from the obstacle. The distance measuring sensor 38 may be configured to emit light, radio waves, or ultrasonic waves toward surroundings of the off-road vehicle 1 and receive reflected waves. For example, the distance measuring sensor 38 may be a LiDAR (Light Detection and Ranging) sensor. The distance measuring sensor 38 may be an infrared distance measuring sensor, a millimeter-wave radar, or a depth-sensing camera.

The camera 39 takes images of surroundings of the off-road vehicle 1. The number of cameras 39 is one or more. The occupant sensor 40 detects whether or not a person is on the off-road vehicle 1. The occupant sensor 40 may be a pressure-sensitive sensor located in a seat portion of the occupant seat or may be a camera that takes images of the interior space S. The road surface condition sensor 41 may be, for example, an optical sensor that detects the road surface condition by emitting light to the road surface and analyzing reflected light. The optical sensor may irradiate the road surface with infrared light to detect the presence of moisture or ice on the road surface and the thickness of a water film or an ice film on the road surface or may irradiate the road surface with laser light to detect irregularities of the road surface.

The autonomous driving ECU 10 includes a processor 11, a system memory 12, a storage memory 13, and a communication interface 14. The processor 11 may include a CPU (central processing unit). The system memory 12 may include a volatile memory. The storage memory 13 may include a hard disk, a non-volatile memory, or a combination thereof. The storage memory 13 stores map information M of an area in which the off-road vehicle 1 may travel. The storage memory 13 stores a program P1. A configuration in which the processor 11 executes the program P1 read into the system memory 12 is an example of processing circuitry 15. The communication interface 14 is connected to the communication bus 45.

While collating the current position of the off-road vehicle 1 with a map indicated by the map information M, the processing circuitry 15 controls the motor 31, the brake actuator 32, and the steering actuator 33 such that the off-road vehicle 1 travels along a planned travel route. The processing circuitry 15 controls the motor 31, the brake actuator 32, and the steering actuator 33 such that the off-road vehicle 1 does not collide with the obstacles detected by the distance measuring sensor 38. The planned travel route may be commanded by the server 2, may be prestored in the autonomous driving ECU 10, or may be registered in the autonomous driving ECU 10 by an input from a user of the off-road vehicle 1.

The control system 50 of the off-road vehicle 1 includes a travel management ECU 20. The travel management ECU 20 is travel management equipment that manages the travel of the off-road vehicle 1. A wireless communicator 42 is electrically connected to the communication bus 45. The wireless communicator 42 is an interface for connecting to the communication network N. When a travel abnormality occurs in the off-road vehicle 1, the travel management ECU 20 transmits report information to the server 2 through the wireless communicator 42.

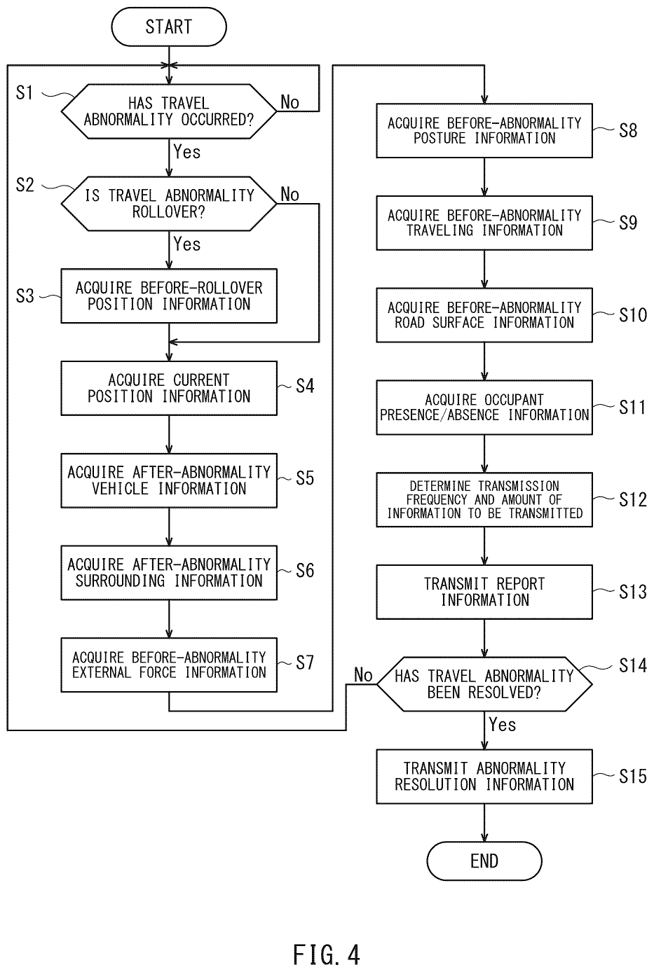

The travel management ECU 20 includes a processor 21, a system memory 22, a storage memory 23, and a communication interface 24. The processor 21 may include a CPU (central processing unit). The system memory 22 may include a volatile memory. The storage memory 23 may include a hard disk, a non-volatile memory, or a combination thereof. The storage memory 23 stores a program P2. A configuration in which the processor 21 executes the program P2 read into the system memory 22 is an example of processing circuitry 25. The communication interface 24 is connected to the communication bus 45. The processor 21 stores data, detected by the satellite positioning sensor 34, the IMU 35, the vehicle speed sensor 36, the steering sensor 37, the distance measuring sensor 38, the camera 39, the occupant sensor 40, and the road surface condition sensor 41, in the storage memory 23. Processing executed by the processing circuitry 25 will be described later with reference to FIG. 4.

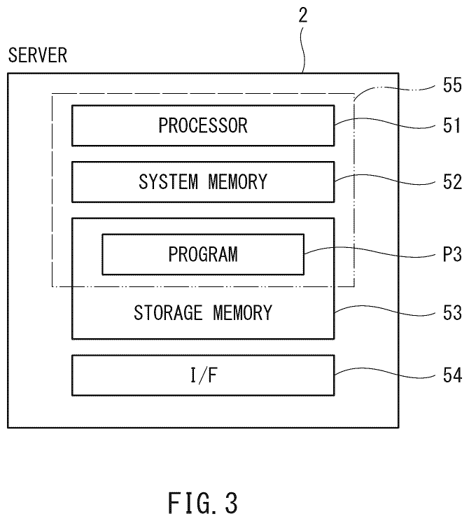

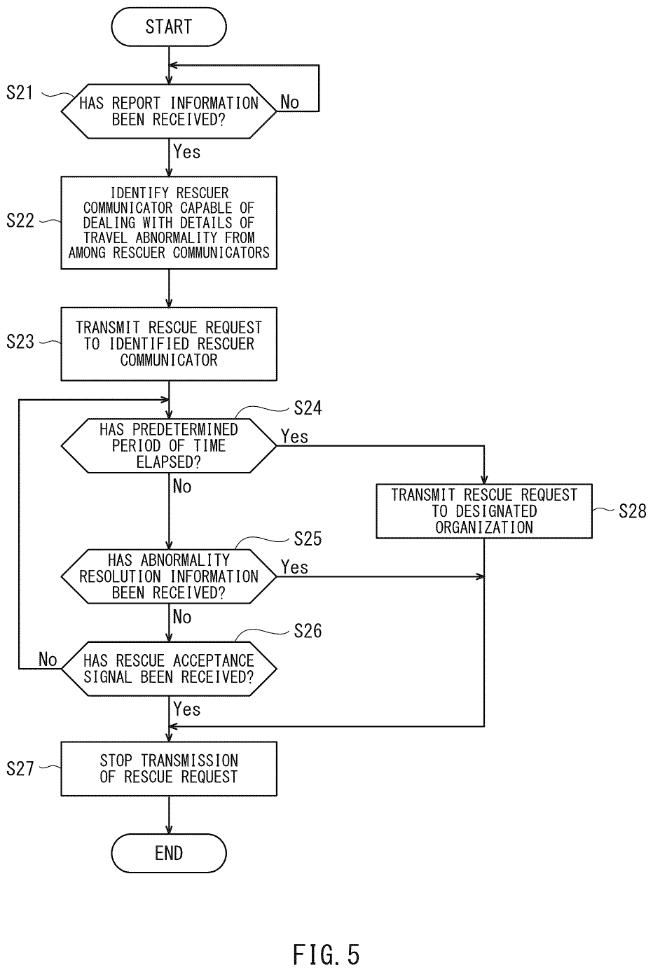

FIG. 3 is a block diagram of the server 2 shown in FIG. 1. As shown in FIG. 3, the server 2 includes a processor 51, a system memory 52, a storage memory 53, and a communication interface 54. The processor 51 may include a CPU (central processing unit). The system memory 52 may include a volatile memory. The storage memory 53 may include a hard disk, a non-volatile memory, or a combination thereof. The storage memory 53 stores a program P3. A configuration in which the processor 51 executes the program P3 read into the system memory 52 is an example of processing circuitry 55. Processing executed by the processing circuitry 55 will be described later with reference to FIG. 5.

FIG. 4 is a flowchart for explaining processing of the travel management ECU 20 shown in FIG. 2. Hereinafter, the processing of the travel management ECU 20 will be described along the flow of FIG. 4 with reference to FIGS. 1 and 2. The processing of the travel management ECU 20 is performed by the processing circuitry 25.

In Step S1, the travel management ECU 20 determines whether or not the travel abnormality has occurred in the off-road vehicle 1 during travel. Examples of the travel abnormality include various abnormalities including an abnormality that requires rescue. For example, the travel abnormality includes an abnormality in which the off-road vehicle 1 does not move in accordance with a command from the autonomous driving ECU 10. The travel abnormality includes a state in which it is estimated that the off-road vehicle 1 is unable to travel due to stuck, side rollover, collision with an obstacle, or the like.

Specifically, the travel abnormality may include an abnormality in which the amount of change in the position of the off-road vehicle 1 detected by the satellite positioning sensor 34 or the like is less than a predetermined ratio of a planned travel distance calculated from the rotational speed of the motor 31 commanded by the autonomous driving ECU 10. For example, an abnormality may occur in which the off-road vehicle 1 merely moves a distance corresponding to less than the predetermined ratio of the planned travel distance based on the command from the travel management ECU 20, because the wheel 1a of the off-road vehicle 1 is punctured and the off-road vehicle 1 does not move at a commanded speed. In addition to puncture, the travel abnormality may include fuel depletion and battery depletion.

The travel abnormality may include an abnormality in which even when the autonomous driving ECU 10 issues a drive command to the motor 31, the position of the off-road vehicle 1 detected by the satellite positioning sensor 34 does not change. For example, an abnormality may occur in which the wheel 1a of the off-road vehicle 1 is unable to escape from sand or a depression, and therefore, even when the autonomous driving ECU 10 issues the drive command to the motor 31, the position of the off-road vehicle 1 detected by the satellite positioning sensor 34 does not change.

The travel abnormality may include an abnormality in which the off-road vehicle 1 is in the rollover state. For example, the travel management ECU 20 may calculate an inclination angle of the off-road vehicle 1 to the direction of gravitational force from data detected by the IMU 35, and when the inclination angle exceeds a predetermined angle threshold, the travel management ECU 20 may determine that the off-road vehicle 1 has rolled over. The angle threshold may be, for example, a value selected from a range of 40°to 80°.

The travel abnormality may include an abnormality in which an accident has occurred in which the off-road vehicle 1 has collided with an obstacle or another vehicle. When the acceleration detected by the IMU 35 exceeds a predetermined limit threshold, the travel management ECU 20 may determine that a collision accident has occurred. When multiple types of travel abnormalities are assumed, the travel management ECU 20 may identify one travel abnormality from among the travel abnormalities based on a detected value of the sensor.

When it is determined that the travel abnormality has occurred, the travel management ECU 20 determines in Step S2 whether or not the travel abnormality is the rollover of the off-road vehicle 1. When it is determined in Step S2 that the travel abnormality is the rollover, the travel management ECU 20 acquires before-rollover position information in Step S3. The before-rollover position information indicates the position of the off-road vehicle 1 immediately before it is determined that the rollover of the off-road vehicle 1 has occurred.

Specifically, the travel management ECU 20 extracts the before-rollover position information, which indicates the position of the off-road vehicle 1 detected by the satellite positioning sensor 34 immediately before it is determined that the travel abnormality of the off-road vehicle 1 has occurred, from time-series data of the position of the off-road vehicle 1 detected by the satellite positioning sensor 34 and accumulated in the storage memory 23, and records the before-rollover position information in a report information list of the storage memory 23.

When it is determined in Step S2 that the travel abnormality is not the rollover, the process skips Step S3 and proceeds to Step S4. In FIG. 4, for the sake of convenience, Steps S4 to S12 are shown as being executed in series. However, at least two of Steps S4 to S12 may be executed in parallel. Moreover, the order of execution of at least two of Steps S4 to S12 may be switched. Furthermore, at least one of Steps S4 to S12 may be omitted.

In Step S4, the travel management ECU 20 acquires current position information of the off-road vehicle 1. Specifically, the travel management ECU 20 records the current position information, which indicates the current position of the off-road vehicle 1 detected by the satellite positioning sensor 34, in the report information list of the storage memory 23.

In Step S5, the travel management ECU 20 acquires information indicating the current vehicle state of the off-road vehicle 1 as after-abnormality vehicle information indicating the vehicle state of the off-road vehicle 1 after the occurrence of the travel abnormality. Specifically, the travel management ECU 20 records the information indicating the current vehicle state of the off-road vehicle 1 in the report information list of the storage memory 23.

For example, the information indicating the current vehicle state of the off-road vehicle 1 may be information detected by at least one of the IMU 35, the vehicle speed sensor 36, and the steering sensor 37. The vehicle state may be the posture of the off-road vehicle 1 which is calculated based on the data detected by the IMU 35. Information indicating the posture of the off-road vehicle 1 after the occurrence of the travel abnormality may be referred to as after-abnormality posture information. The vehicle state may be the presence or absence of the movement of the off-road vehicle 1 which is determined based on data detected by the vehicle speed sensor 36.

When the travel abnormality is the rollover, the information indicating the vehicle state may include a distance between the position of the off-road vehicle 1 at the start of the rollover and the position of the off-road vehicle 1 at the current time. The distance may be the amount of change in the position detected by the satellite positioning sensor 34 or may be calculated based on double integration of the acceleration detected by the IMU 35.

In Step S6, the travel management ECU 20 acquires after-abnormality surrounding information indicating the surrounding condition of the off-road vehicle 1 after the occurrence of the travel abnormality. Specifically, the travel management ECU 20 records the after-abnormality surrounding information, which indicates the surrounding condition of the off-road vehicle 1 after the occurrence of the travel abnormality, in a normal information list of the storage memory 23. For example, the after-abnormality surrounding information may be an image of the surroundings of the off-road vehicle 1 taken by the camera 39 or may be a distance from the off-road vehicle 1 to an obstacle measured by the distance measuring sensor 38. Thus, the presence or absence of a gap between the off-road vehicle 1 and the obstacle around the off-road vehicle 1 can be grasped.

In Step S7, the travel management ECU 20 acquires before-abnormality external force information. Specifically, the travel management ECU 20 extracts the acceleration, which is detected by the IMU 35 immediately before it is determined that the travel abnormality of the off-road vehicle 1 has occurred, from time-series data of acceleration data detected by the IMU 35 and accumulated in the storage memory 23, and records a value of the acceleration or a value obtained by converting the acceleration into external force, in the report information list of the storage memory 23.

In Step S8, the travel management ECU 20 acquires before-abnormality posture information. Specifically, the posture of the off-road vehicle 1 may be the inclination angle of the off-road vehicle 1 to the direction of gravitational force which is calculated based on the data detected by the IMU 35. The travel management ECU 20 extracts the posture of the off-road vehicle 1, which is detected immediately before it is determined that the travel abnormality of the off-road vehicle 1 has occurred, from time-series data of the posture of the off-road vehicle 1 accumulated in the storage memory 23, and records the posture of the off-road vehicle 1 in the report information list of the storage memory 23.

The posture of the off-road vehicle 1 may be estimated by analyzing the image of the surroundings of the off-road vehicle 1 taken by the camera 39 or may be estimated based on the stroke of the suspension detected by a suspension stroke sensor of the off-road vehicle 1. For example, when the off-road vehicle 1 rolls over, and the wheels 1a are not on the ground, the stroke of the suspension exceeds a threshold.

By referring to both the before-abnormality external force information and the before-abnormality posture information, it is possible to narrow down a portion of the off-road vehicle 1 to which the external force that causes the travel abnormality has been applied, which helps to identify an appropriate measure for resolving the travel abnormality.

In Step S9, the travel management ECU 20 acquires before-abnormality traveling information indicating the traveling state of the off-road vehicle 1 immediately before the occurrence of the travel abnormality. Specifically, the travel management ECU 20 extracts the traveling state of the off-road vehicle 1, which is detected immediately before it is determined that the travel abnormality of the off-road vehicle 1 has occurred, from time-series data of the traveling state of the off-road vehicle 1 accumulated in the storage memory 23, and records the traveling state of the off-road vehicle 1 in the report information list of the storage memory 23.

The traveling state may include at least one of the traveling speed detected by the vehicle speed sensor 36, the steering angle detected by the steering sensor 37, vertical acceleration detected by the IMU 35, and the posture of the off-road vehicle 1 detected by the IMU 35.

In Step S10, the travel management ECU 20 acquires before-abnormality road surface information indicating the condition of the road surface detected by the road surface condition sensor 41 immediately before the occurrence of the travel abnormality. Specifically, the travel management ECU 20 extracts road surface information, which is detected immediately before it is determined that the travel abnormality of the off-road vehicle 1 has occurred, from time-series data of the road surface information accumulated in the storage memory 23, and records the road surface information in the report information list of the storage memory 23.

In Step S11, the travel management ECU 20 acquires occupant presence/absence information indicating whether or not a person is on the off-road vehicle 1 immediately before the occurrence of the travel abnormality. Specifically, the travel management ECU 20 extracts the occupant presence/absence information, which is detected immediately before it is determined that the travel abnormality of the off-road vehicle 1 has occurred, from time-series data of the occupant presence/absence information accumulated in the storage memory 23, and records the occupant presence/absence information in the report information list of the storage memory 23.

In Step S12, the travel management ECU 20 determines the transmission frequency of the report information and the amount of report information to be transmitted in Step S13 described later. In Step S13, the travel management ECU 20 transmits the report information to the server 2 that is rescue-side equipment.

The report information includes at least one selected from pieces of information recorded in the above-described report information. To be specific, the report information includes at least one selected from the group consisting of the before-rollover position information, the current position information, the after-abnormality vehicle information, the after-abnormality surrounding information, the before-abnormality external force information, the before-abnormality posture information, the before-abnormality traveling information, the before-abnormality road surface information, and the occupant presence/absence information.

When it is determined that a person is on the off-road vehicle 1 before the occurrence of the travel abnormality, the travel management ECU 20 may make the transmission frequency of the report information to the server 2 different from that when it is determined that no person is on the off-road vehicle 1 before the occurrence of the travel abnormality or may make the amount of report information different from that when it is determined that no person is on the off-road vehicle 1 before the occurrence of the travel abnormality.

Specifically, when it is determined that a person is on the off-road vehicle 1 before the occurrence of the travel abnormality, the travel management ECU 20 may make the transmission frequency of the report information to the server 2 higher than that when it is determined that no person is on the off-road vehicle 1 before the occurrence of the travel abnormality or may make the amount of report information larger than that when it is determined that no person is on the off-road vehicle 1 before the occurrence of the travel abnormality. Thus, a rescue priority can be changed depending on whether or not a person is on the off-road vehicle 1.

The number of types of information included in the report information may be set larger when it is determined that a person is on the off-road vehicle 1 before the occurrence of the travel abnormality than when it is determined that no person is on the off-road vehicle 1 before the occurrence of the travel abnormality. For example, the number of types of information selected from the group consisting of the before-rollover position information, the current position information, the after-abnormality vehicle information, the after-abnormality surrounding information, the before-abnormality external force information, the before-abnormality posture information, the before-abnormality traveling information, the before-abnormality road surface information, and the occupant presence/absence information and included in the report information may be set larger when it is determined that a person is on the off-road vehicle 1 before the occurrence of the travel abnormality than when it is determined that no person is on the off-road vehicle 1 before the occurrence of the travel abnormality. Thus, the rescue priority can be changed depending on whether or not a person is on the off-road vehicle 1. The transmission frequency of the report information to the server 2 and the amount of report information may be constant.

In Step S14, the travel management ECU 20 determines whether or not the travel abnormality has been resolved. When it is determined that the travel abnormality has not been resolved, the process returns to Step S1. When it is determined that the travel abnormality has been resolved, the travel management ECU 20 transmits abnormality resolution information to the server 2 in Step S15. The abnormality resolution information indicates that the travel abnormality of the off-road vehicle 1 has been resolved. This prevents a rescuer from heading to rescue the off-road vehicle 1 even though the travel abnormality has been resolved.

When an operator who has confirmed the report information after the transmission of the report information determines that the determination that the travel abnormality has occurred is an erroneous determination, the abnormality resolution information indicating that the transmission of the report information is erroneous may be transmitted to the server 2 by the operation of the operator.

For example, the operator may be an occupant who is on the off-road vehicle 1. In this case, when the occupant determines that no travel abnormality has occurred, the occupant may operate a user interface, connected to the travel management ECU 20 of the off-road vehicle 1, to cancel control that is based on the report information indicating the travel abnormality or cancel the transmission of the report information.

Moreover, the operator may be a manager who is located at a place away from the off-road vehicle 1. Even in this case, when the manager determines that no travel abnormality has occurred, the manager may operate an information terminal, connected to the communication network N, to cancel control that is based on the determination of the travel abnormality or cancel the transmission of the report information. Moreover, when it is determined that the travel abnormality has occurred, the off-road vehicle 1 may travel in a restricted mode. In this case, when it is determined that the travel abnormality state has returned to a normal state, the travel management ECU 20 may cancel control that is based on the determination that the travel abnormality has occurred or cancel the transmission of the report information.

FIG. 5 is a flowchart for explaining processing of the server 2 shown in FIG. 3. Hereinafter, the processing of the server 2 will be described along the flow of FIG. 5 with reference to FIGS. 1 to 3. The processing of the server 2 is performed by the processing circuitry 55. The server 2 may receive the report information from the off-road vehicles including the respective travel management ECUs 20. The following will describe an example in which the server 2 receives the report information transmitted from the travel management ECU 20 of the off-road vehicle 1. In Step S21, the server 2 determines whether or not it has received the report information.

Since the report information includes various pieces of information described above, the server 2 can narrow down the details of the travel abnormality with reference to the report information, which helps to identify an appropriate measure for resolving the travel abnormality. For example, when the report information includes both the before-rollover position information and after-rollover position information, the server 2 can identify the manner of the rollover, which helps to rescue the vehicle that has rolled over.

When it is determined that the server 2 has received the report information, the server 2 identifies a rescuer communicator capable of dealing with the details of the travel abnormality of the off-road vehicle 1 from among rescuer communicators in Step S22. Herein, the rescuer communicator denotes a communicator associated with a person who performs a rescue operation. Examples of the rescuer communicator include a communicator of the vehicle 3 on which a person is and the information processing terminal 4 possessed by a person. The server 2 periodically receives the position information from the vehicle 3 and the information processing terminal 4.

When the travel abnormality of the off-road vehicle 1 is the rollover, the server 2 identifies the rescuer communicators located within a predetermined distance from the off-road vehicle 1 in order to perform the rescue operation with persons. When the travel abnormality of the off-road vehicle 1 is an event in which the off-road vehicle 1 is stuck in sand or a depression and is unable to move, the server 2 identifies, from among the rescuer communicators each associated with a device that tows the off-road vehicle 1, the rescuer communicator located within a predetermined distance from the off-road vehicle 1.

In Step S23, the travel management ECU 20 transmits a rescue request to the identified rescuer communicator. The rescue request may include the above-described report information. In Step S24, the server 2 determines whether or not a predetermined period of time has elapsed since the transmission of the rescue request. When it is determined that the predetermined period of time has not elapsed, the server 2 determines in Step S25 whether or not it has received the abnormality resolution information from the off-road vehicle 1.

When the server 2 has not received the abnormality resolution information, the server 2 determines in Step S26 whether or not it has received a rescue acceptance signal from the rescuer communicator. To be specific, when a user of the rescuer communicator which has received the rescue request accepts the rescue request, the user transmits the rescue acceptance signal to the server 2 through the rescuer communicator.

When the server 2 receives the rescue acceptance signal, the server 2 stops the transmission of the rescue request in Step S27. On the other hand, when the server 2 cannot receive the rescue acceptance signal, the process returns to Step S24. When it is determined in Step S24 that the predetermined period of time has elapsed, the server 2 transmits the rescue request to a designated organization in Step S28 and stops the transmission of the rescue request in Step S27. The designated organization is, for example, a public rescue organization. When it is determined in Step S25 that the server 2 has received the abnormality resolution information, the server 2 stops the transmission of the rescue request in Step S27.

The rescue request may be transmitted to respective destinations, such as vehicles and facilities. In this case, when the rescue operation is completed, the transmission of the rescue request to the destinations to which the rescue request has been transmitted may be stopped. Moreover, when the rescuer to head to the rescue operation is determined, information for requesting suspension of the rescue operation may be transmitted from the rescuer or a rescue-requesting vehicle to the destinations except for the rescuer.

In the above-described embodiment, the travel management ECU 20 of the off-road vehicle 1 transmits the report information to the server 2. However, the report information may be transmitted to the rescue-side equipment other than the server 2. For example, the travel management ECU 20 of the off-road vehicle 1 may directly transmit the report information through wireless communication to the communicator of the vehicle 3 and the information processing terminal 4 as the rescue-side equipment.

A computer program including a computer instruction is stored in a memory. The computer instruction provides logic and a routine that enable hardware to execute the method disclosed in the present specification. The hardware includes, for example, processing circuitry or circuitry. The computer program may be implemented in a known format on a computer-readable storage medium, a computer program product, a memory device, a recording medium such as a CD-ROM or a DVD, and/or a memory of FPGAs or ASICs.

It is preferable that the off-road vehicle 1 include a protection structure for protecting the interior space S at the time of the rollover. However, the off-road vehicle 1 does not have to include such a protection structure. It is sufficient that the off-road vehicle 1 can perform autonomous driving. Regarding the number of wheels and the sizes of the wheels, various structures can be adopted. The type of the occupant seat may be a single-row seat type or a two-row seat type. The off-road vehicle 1 may be a three-wheeled vehicle or a straddle buggy vehicle.

As long as the server 2 can receive the information indicating the state of the off-road vehicle 1, a communication apparatus located in the off-road vehicle 1 may be able to transmit information to the server 2 through the communication network N. The communication apparatus located in the off-road vehicle 1 may be able to transmit information to the server 2 through a mobile information terminal mounted on the off-road vehicle 1. The communication network N may be a line that performs wireless communication between a base station and a terminal or a line that performs wireless communication between an artificial satellite and a terminal. The communication network N may be a public line or a dedicated line.

A sensor other than the IMU may be used to detect the vehicle posture in the travel abnormality state, such as the stuck state or the rollover state. For example, a sensor that causes a change in a detected value in response to a change in posture may be used. Specifically, the posture in the travel abnormality state may be estimated based on a detection result of a sensor that detects the amount of stroke of a suspension, a sensor that detects a fuel liquid level, and a sensor that detects tire air pressure. Moreover, the vehicle posture in the travel abnormality state may be detected based on a detection result of a surrounding condition sensor.

Information transmitted to the server 2 may include information regarding a drive state, such as a differential/differential lock state and a two-wheel/four-wheel drive state. Thus, the presence or absence of the occurrence of the stuck state can be easily estimated. Moreover, in addition to the vehicle speed and the steering amount, information regarding the loading state of cargo which affects the vehicle behavior may be transmitted to the server 2.

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

The functionality of the elements disclosed in the present specification may be implemented using one or more circuits or processing circuits, including general-purpose processors, special-purpose processors, integrated circuits, ASICs (Application Specific Integrated Circuits), FPGAs (Field Programmable Gate Arrays), and/or conventional circuits. The functionality of the elements disclosed in the present specification may be implemented using one or more circuits or processing circuits including a combination of general-purpose processors, special-purpose processors, integrated circuits, ASICs, FPGAs, and conventional circuits. The one or more circuits or processing circuits may be programmed using one or more programs stored together or separately in one or more memories, or may be configured by a different method so as to execute the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality alone or in combination. The hardware may be any hardware as long as it is hardware disclosed in the present specification and is programmed or configured to perform the recited functionality.

### ASPECTS

The above-described embodiment has described specific examples of the following aspects.

### First Aspect

Travel management equipment for an off-road vehicle, the travel management equipment being equipment that manages travel of the off-road vehicle,
the travel management equipment including processing circuitry configured to
   determine that a travel abnormality has occurred in the off-road vehicle during the travel,
   acquire after-abnormality vehicle information indicating a vehicle state of the off-road vehicle after an occurrence of the travel abnormality, and
   transmit report information including the after-abnormality vehicle information to rescue-side equipment.

According to the first aspect, by notifying the rescue-side equipment of the vehicle state of the autonomously-driven off-road vehicle in which the travel abnormality has occurred, the rescue side can grasp a measure necessary to resolve the travel abnormality. For example, the rescue side identifies one travel abnormality from the travel abnormalities and notifies the rescue-side equipment of the identified travel abnormality. Thus, the accuracy in determining the measure necessary to resolve the travel abnormality can be improved.

### Second Aspect

The travel management equipment according to the first aspect, wherein the after-abnormality vehicle information includes after-abnormality posture information indicating a posture of the off-road vehicle after the occurrence of the travel abnormality.

According to the second aspect, since the posture of the vehicle after the occurrence of the travel abnormality is identified, the details of the travel abnormality can be narrowed down, which helps to identify an appropriate measure for resolving the travel abnormality. For example, the rescue side identifies a portion of the vehicle which is located on a lower side, as the posture of the vehicle after the occurrence of the travel abnormality. Thus, the rescue side can easily take a measure necessary to resolve the rollover state. For example, from the posture of the vehicle after the occurrence of the travel abnormality, the rescue side determines whether or not a winch can be utilized. This makes it easy to appropriately select the type of a vehicle used for the rescue operation.

### Third Aspect

The travel management equipment according to the first or second aspect, wherein:
the processing circuitry acquires after-abnormality surrounding information indicating a surrounding condition of the off-road vehicle after the occurrence of the travel abnormality; and
the report information further includes the after-abnormality surrounding information.

According to the third aspect, since the surrounding condition of the vehicle after the occurrence of the travel abnormality can be identified, the details of the travel abnormality can be narrowed down, which helps to identify an appropriate measure for resolving the travel abnormality. For example, the rescue side grasps whether there are many or few obstacles as the surrounding condition after the occurrence of the abnormality. Thus, the rescue side can determine whether to prepare materials for removing the obstacles for the rescue. Moreover, since the rescue side grasps the surrounding condition after the occurrence of the abnormality, the rescue side can appropriately determine the rescue priority. When the rescue side determines that the priority is low, the rescue side may decide to prioritize other operations and perform the rescue later. For example, in the case of an unmanned vehicle, the priority may be determined to be low if it is judged that the vehicle has little adverse impact on the travel of other vehicles.

### Fourth Aspect

The travel management equipment according to any one of the first to third aspects, wherein:
the processing circuitry acquires before-abnormality external force information regarding external force applied to the off-road vehicle before the occurrence of the travel abnormality; and
the report information further includes the before-abnormality external force information.

According to the fourth aspect, since the external force applied to the vehicle before the occurrence of the travel abnormality is identified, the details of the travel abnormality can be narrowed down, which helps to identify an appropriate measure for resolving the travel abnormality. For example, since the external force applied before the occurrence of the travel abnormality is identified, the rescue side can easily grasp whether or not the travel abnormality is an abnormality caused by a collision with an obstacle or an animal. Since the external force applied before the occurrence of the travel abnormality is identified, the rescue side can easily grasp whether or not the travel abnormality is the side rollover caused by centrifugal force.

### Fifth Aspect

The travel management equipment according to the fourth aspect, wherein:
the processing circuitry acquires before-abnormality posture information indicating a change in a posture of the off-road vehicle before the occurrence of the travel abnormality; and
the report information further includes the before-abnormality external force information and the before-abnormality posture information.

According to the fifth aspect, based on the information indicating the external force and the posture before the occurrence of the travel abnormality and the after-abnormality vehicle information after the occurrence of the travel abnormality, the details of the travel abnormality can be narrowed down, which helps to identify an appropriate measure for resolving the travel abnormality.

### Sixth Aspect

The travel management equipment according to any one of the first to fifth aspects, wherein:
the processing circuitry acquires before-abnormality traveling information indicating a traveling state of the off-road vehicle before the occurrence of the travel abnormality; and
the report information further includes the before-abnormality traveling information.

According to the sixth aspect, since the traveling state of the vehicle before the occurrence of the travel abnormality is identified, the details of the travel abnormality can be narrowed down, which helps to identify an appropriate measure for resolving the travel abnormality. For example, the rescue side can estimate the type of the travel abnormality from the traveling state before the occurrence of the travel abnormality. Thus, the rescue side can perform an appropriate rescue operation. Even when the vehicle is in the side rollover state, the rescue side can easily perform an appropriate rescue operation by estimating whether the side rollover has been caused during turning, by running over an obstacle during straight travel, or by a depression on the road surface.

### Seventh Aspect

The travel management equipment according to any one of the first to sixth aspects, wherein:
the processing circuitry acquires before-abnormality road surface information indicating a condition of a road surface on which the off-road vehicle travels before the occurrence of the travel abnormality; and
the report information further includes the before-abnormality road surface information.

According to the seventh aspect, since the road surface condition before the occurrence of the travel abnormality is identified, the details of the travel abnormality can be narrowed down, which helps to identify an appropriate measure for resolving the travel abnormality. For example, the rescue side determines whether the off-road vehicle is in a rocky area traveling state or a sand area traveling state. Thus, the rescue side can estimate the type of the travel abnormality, and therefore, can perform an appropriate rescue operation.

Eighth Aspect

The travel management equipment according to any one of the first to seventh aspects, wherein:
the travel abnormality includes a rollover of the off-road vehicle;
the processing circuitry acquires before-rollover position information indicating a position of the off-road vehicle before the occurrence of the rollover and after-rollover position information indicating a position of the off-road vehicle after the occurrence of the rollover; and
the report information further includes the before-rollover position information and the after-rollover position information.

According to the eighth aspect, a start position of the rollover can be identified, which helps to rescue the vehicle that has rolled over. For example, the vehicle may move off the travel route from before the rollover to after the rollover, such as when the vehicle falls from a cliff. In such a case, the rescue side can easily perform the rescue by identifying the start position of the rollover.

### Ninth Aspect

The travel management equipment according to any one of the first to eighth aspects, wherein:
the processing circuitry determines that the travel abnormality has been resolved after the occurrence of the travel abnormality; and
when it is determined that the travel abnormality has been resolved, the processing circuitry transmits abnormality resolution information indicating that the travel abnormality has been resolved, to the rescue-side equipment.

According to the ninth aspect, a third party can be prevented from heading to rescue the vehicle even though the travel abnormality has been resolved.

### Tenth Aspect

The travel management equipment according to any one of the first to ninth aspects, wherein:
the processing circuitry acquires occupant presence/absence information indicating whether or not a person is on the off-road vehicle before the occurrence of the travel abnormality; and
the report information further includes the occupant presence/absence information.

According to the tenth aspect, the rescue priority can be determined depending on whether or not a person is on the vehicle.

### Eleventh Aspect

The travel management equipment according to any one of the first to tenth aspects, wherein:
the processing circuitry acquires occupant presence/absence information indicating whether or not a person is on the off-road vehicle before the occurrence of the travel abnormality; and
when the person is on the off-road vehicle before the occurrence of the travel abnormality, the processing circuitry makes a transmission frequency of the report information to the rescue-side equipment different from that when no person is on the off-road vehicle before the occurrence of the travel abnormality or makes an amount of report information different from that when no person is on the off-road vehicle before the occurrence of the travel abnormality.

According to the eleventh aspect, the transmission frequency or the amount of information differs depending on the presence or absence of the person on the vehicle, which helps to identify an appropriate measure.

### Twelfth Aspect

The travel management equipment according to any one of the first to eleventh aspects, wherein when it is determined that a person is on the off-road vehicle before the occurrence of the travel abnormality, the processing circuitry makes a transmission frequency of the report information to the rescue-side equipment higher than that when it is determined that no person is on the off-road vehicle before the occurrence of the travel abnormality or makes an amount of report information larger than that when it is determined that no person is on the off-road vehicle before the occurrence of the travel abnormality.

According to the twelfth aspect, when a person is on the vehicle, the transmission frequency is made higher, or the amount of information is made larger, which helps to optimize a measure for the vehicle on which a person is.

### Thirteenth Aspect

The travel management equipment according to any one of the first to twelfth aspects, wherein the travel abnormality includes an abnormality in which the off-road vehicle does not move even though a wheel of the off-road vehicle is driven.

According to the thirteenth aspect, for example, when the wheel is stuck in a desert, the rescue-side equipment is notified of this. Thus, the rescue side can grasp a measure necessary to get the wheel out of sand. As abnormalities in which the vehicle does not move other than the stuck state, for example, a state in which the vehicle is caught between obstacles and a state in which the vehicle is stranded on the rocky area are assumed.

### Fourteenth Aspect

The travel management equipment according to any one of the first to thirteenth aspects, wherein the travel abnormality includes an abnormality in which the off-road vehicle has rolled over.

According to the fourteenth aspect, when the vehicle is in the rollover state, the rescue-side equipment is notified of this. Thus, the rescue side can grasp a measure necessary to return the vehicle from the rollover state to the normal state.

### Fifteenth Aspect

Travel management equipment for an off-road vehicle, the travel management equipment being equipment that manages travel of the off-road vehicle,
the travel management equipment including processing circuitry configured to
   determine that a travel abnormality has occurred in the off-road vehicle during the travel,
   acquire before-abnormality information indicating information related to the off-road vehicle before an occurrence of the travel abnormality, and
   transmit report information including the before-abnormality information to rescue-side equipment.

According to the fifteenth aspect, the rescue-side equipment is notified of the information related to the vehicle before the occurrence of the travel abnormality. Thus, the details of the travel abnormality can be narrowed down, which helps to identify an appropriate measure for resolving the travel abnormality.

### Sixteenth Aspect

The travel management equipment according to the fifteenth aspect, wherein the before-abnormality information includes before-abnormality external force information regarding external force applied to the off-road vehicle before the occurrence of the travel abnormality.

According to the sixteenth aspect, the rescue-side equipment is notified of the external force applied to the vehicle before the occurrence of the travel abnormality. Thus, the details of the travel abnormality can be narrowed down, which helps to identify an appropriate measure for resolving the travel abnormality.

### Seventeenth Aspect

The travel management equipment according to the fifteenth or sixteenth aspect, wherein the before-abnormality information includes before-abnormality traveling information indicating a traveling state of the off-road vehicle before the occurrence of the travel abnormality or before-abnormality road surface information indicating a condition of a road surface on which the off-road vehicle travels before the occurrence of the travel abnormality.

According to the seventeenth aspect, the rescue-side equipment is notified of the traveling state of the vehicle or the road surface condition before the occurrence of the travel abnormality. Thus, the details of the travel abnormality can be narrowed down, which helps to identify an appropriate measure for resolving the travel abnormality.

### Eighteenth Aspect

An off-road vehicle including the travel management equipment according to any one of the first to seventeenth aspects.

What is claimed is:

1. Travel management equipment for an off-road vehicle, the travel management equipment being equipment that manages travel of the off-road vehicle,
the travel management equipment comprising processing circuitry configured to
determine that a travel abnormality has occurred in the off-road vehicle during the travel,
acquire after-abnormality vehicle information indicating a vehicle state of the off-road vehicle after an occurrence of the travel abnormality, and
transmit report information including the after-abnormality vehicle information to rescue-side equipment.

2. The travel management equipment according to claim 1, wherein the after-abnormality vehicle information includes after-abnormality posture information indicating a posture of the off-road vehicle after the occurrence of the travel abnormality.

3. The travel management equipment according to claim 1, wherein:
the processing circuitry acquires after-abnormality surrounding information indicating a surrounding condition of the off-road vehicle after the occurrence of the travel abnormality; and
the report information further includes the after-abnormality surrounding information.

4. The travel management equipment according to claim 1, wherein:
the processing circuitry acquires before-abnormality external force information regarding external force applied to the off-road vehicle before the occurrence of the travel abnormality; and
the report information further includes the before-abnormality external force information.

5. The travel management equipment according to claim 4, wherein:
the processing circuitry acquires before-abnormality posture information indicating a change in a posture of the off-road vehicle before the occurrence of the travel abnormality; and
the report information further includes the before-abnormality external force information and the before-abnormality posture information.

6. The travel management equipment according to claim 1, wherein:
the processing circuitry acquires before-abnormality traveling information indicating a traveling state of the off-road vehicle before the occurrence of the travel abnormality; and
the report information further includes the before-abnormality traveling information.

7. The travel management equipment according to claim 1, wherein:
the processing circuitry acquires before-abnormality road surface information indicating a condition of a road surface on which the off-road vehicle travels before the occurrence of the travel abnormality; and
the report information further includes the before-abnormality road surface information.

8. The travel management equipment according to claim 1, wherein:
the travel abnormality includes a rollover of the off-road vehicle;
the processing circuitry acquires before-rollover position information indicating a position of the off-road vehicle before the occurrence of the rollover and after-rollover position information indicating a position of the off-road vehicle after the occurrence of the rollover; and
the report information further includes the before-rollover position information and the after-rollover position information.

9. The travel management equipment according to claim 1, wherein:
the processing circuitry determines that the travel abnormality has been resolved after the occurrence of the travel abnormality; and
when it is determined that the travel abnormality has been resolved, the processing circuitry transmits abnormality resolution information indicating that the travel abnormality has been resolved, to the rescue-side equipment.

10. The travel management equipment according to claim 1, wherein:
the processing circuitry acquires occupant presence/absence information indicating whether or not a person is on the off-road vehicle before the occurrence of the travel abnormality; and
the report information further includes the occupant presence/absence information.

11. The travel management equipment according to claim 1, wherein:
the processing circuitry acquires occupant presence/absence information indicating whether or not a person is on the off-road vehicle before the occurrence of the travel abnormality; and
when the person is on the off-road vehicle before the occurrence of the travel abnormality, the processing circuitry makes a transmission frequency of the report information to the rescue-side equipment different from that when no person is on the off-road vehicle before the occurrence of the travel abnormality or makes an amount of report information different from that when no person is on the off-road vehicle before the occurrence of the travel abnormality.

12. The travel management equipment according to claim 1, wherein when it is determined that a person is on the off-road vehicle before the occurrence of the travel abnormality, the processing circuitry makes a transmission frequency of the report information to the rescue-side equipment higher than that when it is determined that no person is on the off-road vehicle before the occurrence of the travel abnormality or makes an amount of report information larger than that when it is determined that no person is on the off-road vehicle before the occurrence of the travel abnormality.

13. The travel management equipment according to claim 1, wherein the travel abnormality includes an abnormality in which the off-road vehicle does not move even though a wheel of the off-road vehicle is driven.

14. The travel management equipment according to claim 1, wherein the travel abnormality includes an abnormality in which the off-road vehicle has rolled over.

15. Travel management equipment for an off-road vehicle, the travel management equipment being equipment that manages travel of the off-road vehicle,
the travel management equipment comprising processing circuitry configured to
determine that a travel abnormality has occurred in the off-road vehicle during the travel,
acquire before-abnormality information indicating information related to the off-road vehicle before an occurrence of the travel abnormality, and
transmit report information including the before-abnormality information to rescue-side equipment.

16. The travel management equipment according to claim 15, wherein the before-abnormality information includes before-abnormality external force information regarding external force applied to the off-road vehicle before the occurrence of the travel abnormality.

17. The travel management equipment according to claim 15, wherein the before-abnormality information includes before-abnormality traveling information indicating a traveling state of the off-road vehicle before the occurrence of the travel abnormality or before-abnormality road surface information indicating a condition of a road surface on which the off-road vehicle travels before the occurrence of the travel abnormality.

18. An off-road vehicle comprising the travel management equipment according to claim 1.
